(19) United States
(12) Patent Application Publication
(10) Pub. No.: US 2018/0314779 A1
(43) Pub. Date: Nov. 1, 2018

(54) INFORMATION PROCESSING APPARATUS, METHOD FOR CONTROLLING THE SAME, AND STORAGE MEDIUM

(71) Applicant: CANON KABUSHIKI KAISHA, Tokyo (JP)

(72) Inventor: Hayato Koga, Kawasaki-shi (JP)

(21) Appl. No.: 15/960,944

(22) Filed: Apr. 24, 2018

(30) Foreign Application Priority Data
Apr. 28, 2017 (JP) 2017-089724

(51) Int. Cl. G06F 17/50

(52) U.S. Cl. CPC G06F 17/5018

(57) ABSTRACT

An information processing apparatus for simulating at each time a behavior of transformation caused by contact between a finite element analysis model discretized by a finite element method and a member as a contact target includes a division unit configured to divide an element surface, which is a surface of the finite element analysis model, into small areas smaller than the element surface, a specification unit configured to specify each of the small areas where the finite element analysis model and the member come into contact with each other, a storage unit configured to store a contact force for each of the small areas, and a display unit configured to read the contact force for each of the small areas stored in the storage unit and display on a display screen the contact force for each of the small areas with resolution higher than the element surface.

### BACKGROUND OF THE INVENTION

### Field of the Invention

The present disclosure relates to a design of a conveyance path for a recording medium in a printer.

### Description of the Related Art

As a technique for simulating behavior of a recording medium in a conveyance path, Japanese Patent No. 3886627 discusses a method for representing a recording medium as finite elements by a finite element method, determining contact between the recording medium and a guide or a roller in a conveyance path, and numerically solving equations of motion. Then, Japanese Patent No. 3886627 discusses a design support system for solving the equations, thereby evaluating conveyance resistance and an abutment angle due to the contact between the recording medium and the guide.

The shape of this conveyance path is often defined by reading three-dimensional shape information from three-dimensional computer-aided design (CAD) in terms of simulation model creation efficiency and the accuracy of the shape. Further, the shape of the conveyance path is often calculated by being converted into a set of triangular patches for efficiency of contact calculations.

Further, Japanese Patent No. 4049925 discusses a design support system for evaluating an image defect such as scratches or abrasions in printed matter on the recording medium, generated by a strong contact between a recording medium and a guide due to the contact force between the recording medium and the guide

There is a case where a protruding portion such as a rib of a guide or an end portion of a roller comes into strong contact with a recording medium, thereby causing scratches or abrasions in printed matter on the recording medium or the recording medium itself. Such a phenomenon is caused by the action of a local strong contact force.

There are two possible methods for evaluating a local contact force as described above by a simulation. Each method, however, has an issue.

The first method is a method using an equivalent nodal force. In this method, however, the resolution of a local contact force is subject to a limitation on an element size. For example, FIG. 1A illustrates elements 11 of a recording medium discretized by finite elements, finite element nodal points 12, ribs 13, which are guides placed at distances smaller than the element size, and contact points 14 between the recording medium and the ribs 13. Contact forces generated at the contact points 14 are converted into equivalent nodal forces by the shape functions of the finite elements, and the equivalent nodal forces are distributed to the nodal points 12 in the elements 11. If there are a plurality of contact points, the equivalent nodal forces are added up.

For this reason, individual contact forces and the positions of individual contact points between the recording medium and the respective ribs 13, which are placed at distances smaller than the elements of the recording medium, cannot be obtained from the equivalent nodal forces. Further, also when contact forces are displayed using contours as illustrated in FIG. 1B, it is not possible to visually grasp where a strong contact force is generated. In FIG. 1B, a shaded portion represents the contour of a contact force.

To solve such an issue, as in FIG. 1C, each element of the recording medium may be fractionated into half or less of the distance between ribs. In this case, however, a large increase in the calculation time period due to an increase in the number of elements cannot be avoided. Also in FIG. 1C, similar to FIG. 1B, a shaded portion represents the contour of a contact force.

The second method is a method discussed in Japanese Patent No. 4049925. This method is not specified as a finite element method. However, if a contact force at a contact point exceeds an input threshold, the coordinates of the contact point, the contact force, time information, and nodal point information are saved as a file in an external storage device and used to be graphed or visualized in a drawing area.

However, in this method, a local contact force cannot be determined. For example, a protruding portion such as a rib of a guide, which comes into contact with a recording medium, is often round in view of conveyance properties. Such a shape is represented as a set of minute triangular patches. In this case, many contact points densely occur between the recording medium and the set of minute triangular patches. In this case, even if a resultant force obtained by adding up the contact forces at the respective contact points exceeds a threshold, each contact force is less than or equal to the threshold, and therefore is not determined as a contact force exceeding the threshold.

### SUMMARY OF THE INVENTION

The present disclosure is directed to a technique capable of evaluating local contact forces exhaustively without fractionating elements.

According to an aspect of the present disclosure, an information processing apparatus for simulating at each time a behavior of transformation caused by contact between a finite element analysis model discretized by a finite element method and a member as a contact target different from the finite element analysis model includes a division unit configured to divide an element surface, which is a surface of the finite element analysis model, into small areas smaller than the element surface, a specification unit configured to specify each of the small areas where the finite element analysis model and the member come into contact with each other, a storage unit configured to store a contact force with respect to each of the small areas, and a display unit configured to read the contact force with respect to each of the small areas stored in the storage unit and display on a display screen the contact force with respect to each of the small areas with resolution higher than the element surface.

Further features will become apparent from the following description of exemplary embodiments with reference to the attached drawings.

### BRIEF DESCRIPTION OF THE DRAWINGS

FIGS. 1A, 1B, and 1C are diagrams illustrating contact points between a recording medium discretized by finite elements and guide ribs in a conveyance path, and contour display of contact forces when equivalent nodal forces are used.

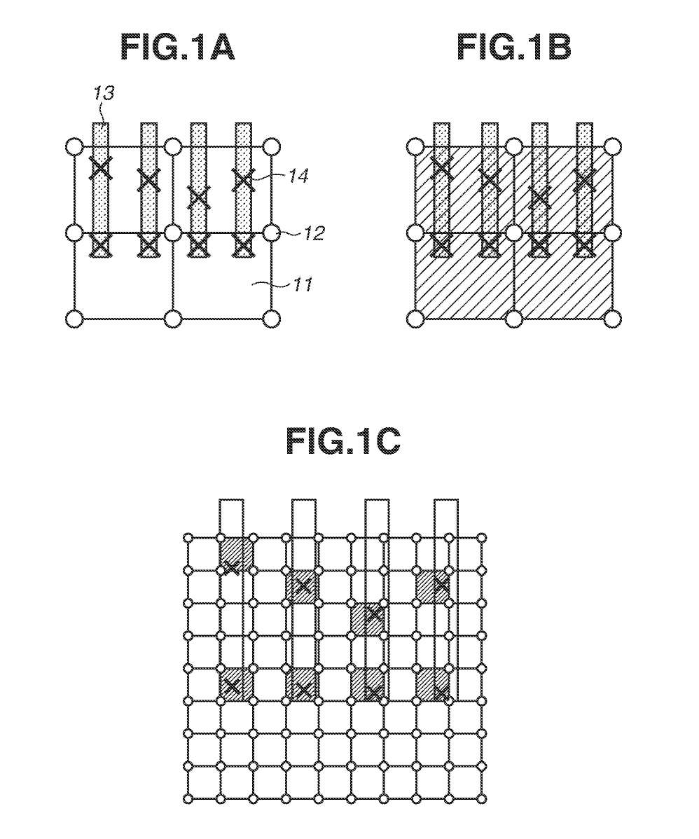

FIG. 2 is a block diagram illustrating a configuration of an information processing apparatus according to an exemplary embodiment.

FIG. 3 is a block diagram illustrating configurations of functions of the information processing apparatus according to the exemplary embodiment.

FIG. 4 is a diagram illustrating an example of a configuration of a screen to be displayed when a simulation is executed in the exemplary embodiment.

FIG. 5 is a diagram illustrating an example of a definition screen for a recording medium according to the exemplary embodiment.

FIG. 6 is a diagram illustrating an example of a definition screen for roller driving conditions according to the exemplary embodiment.

FIG. 7 is a flowchart for motion calculations according to the exemplary embodiment.

FIG. 8 is a diagram illustrating an example of animation display of motion calculation results according to the exemplary embodiment.

FIG. 9 is a diagram illustrating an example of a setting screen for contour display of contact forces according to the exemplary embodiment.

FIGS. 10A and 10B are diagrams illustrating examples of the contour display of the contact forces of the motion calculation results according to the exemplary embodiment.

FIG. 11 is a diagram illustrating an example of a setting screen for vector display of contact forces according to the exemplary embodiment.

FIGS. 12A and 12B are diagrams illustrating examples of the vector display of the contact forces of the motion calculation results according to the exemplary embodiment.

### DESCRIPTION OF THE EMBODIMENTS

Exemplary embodiments of the present disclosure will be specifically described below with reference to the drawings.

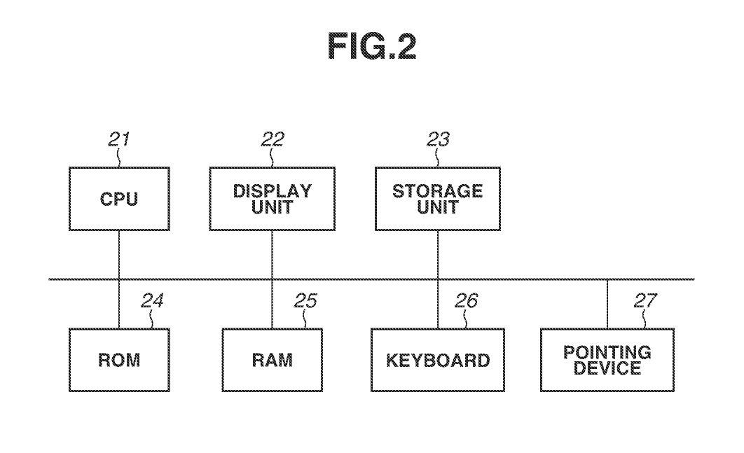

First, a hardware configuration according to a first exemplary embodiment is described. FIG. 2 is a block diagram illustrating an example of the hardware configuration of a design support apparatus, which is an example of an information processing apparatus according to the present exemplary embodiment.

The design support apparatus illustrated in FIG. 2 includes a central processing unit (CPU) 21, a display unit 22, a storage unit 23, a read only memory (ROM) 24, a random access memory (RAM) 25, a keyboard 26, and a pointing device 27.

The CPU 21 is a central processing unit for controlling an entire computer. The display unit 22 displays various input conditions and an analysis result in control executed by the CPU 21. The storage unit 23 is, for example, a hard disk for saving an analysis result obtained by the CPU 21. The ROM 24 stores a control program to be executed by the CPU 21, various application programs, and data. The RAM 25 temporarily saves data when the CPU 21 performs processing while controlling components based on the control program. The keyboard 26 is used by an operator to input various input conditions. The pointing device 27 includes a mouse or a trackball.

The design support apparatus according to the present exemplary embodiment can execute a recording medium conveyance simulation (hereinafter, simply a “simulation”) using the above various kinds of programs. The simulation to be executed in the present exemplary embodiment is achieved by defining a conveyance path and a recording medium and performing motion calculations while a sheet-like recording medium is conveyed in the conveyance path. A description is given below of processing regarding the definitions of a conveyance path, a recording medium, and conveyance conditions, and motion calculations. This processing is achieved by the CPU 21 executing the control program.

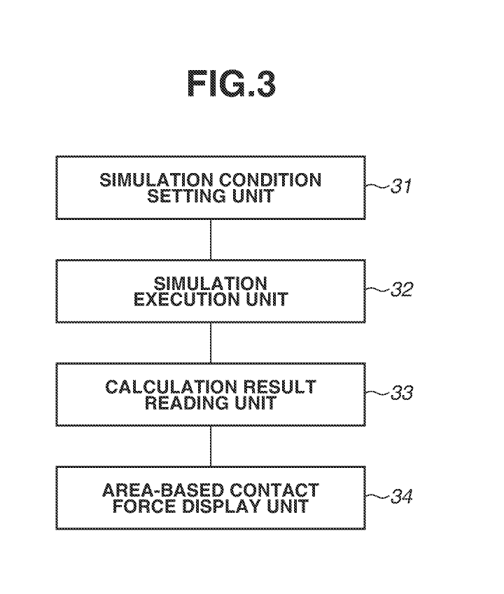

Next, a design support program according to the present exemplary embodiment is described. FIG. 3 is a block diagram illustrating a configuration of the design support program according to the present exemplary embodiment. This block configuration includes a simulation condition setting unit 31, a simulation execution unit 32, a calculation result reading unit 33, and an area-based contact force display unit 34.

The simulation condition setting unit 31 performs a series of preprocesses including the definition of a conveyance path, the definition of a recording medium, and the definition of conveyance conditions. The simulation execution unit 32 calculates the motion of the recording medium according to conditions set by the condition setting unit 31. The calculation result reading unit 33 reads results of a displacement and a speed of coordinates calculated by executing the simulation, a contact force converted into an equivalent nodal force, and a contact force with respect to each small area stored in an area-based contact force storage unit. The area-based contact force display unit 34 displays the read contact force with respect to each small area on a screen.

Next, the processing executed by the design support program according to the present exemplary embodiment is specifically described with reference to diagrams.

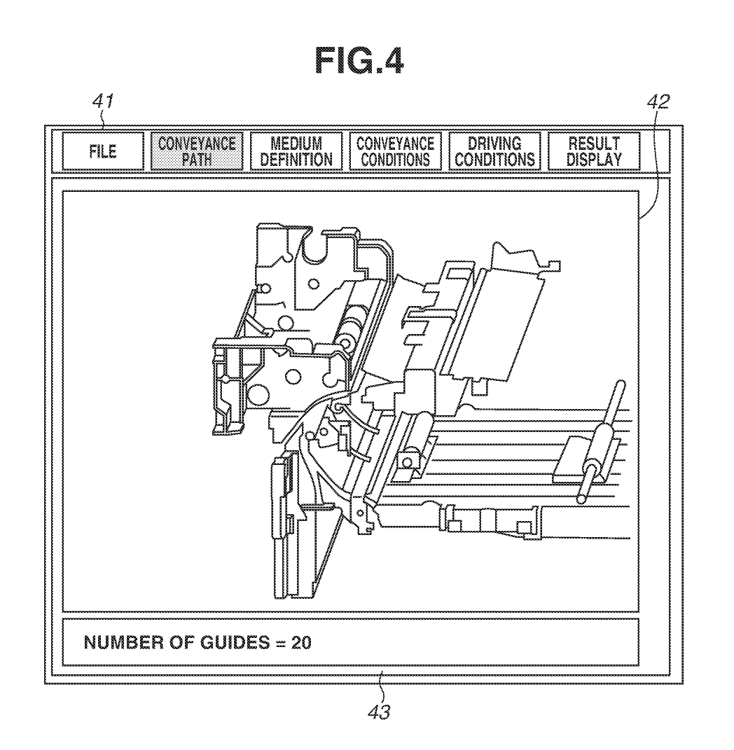

The processing performed by the simulation condition setting unit 31 is described. FIG. 4 is a diagram illustrating an example of a configuration of a screen displayed on the display unit 22 by the CPU 21 when the simulation is executed. The screen illustrated in FIG. 4 includes a menu bar 41, with which mainly procedures are switched, a graphic screen 42, which displays a defined conveyance path and results, and a command field 43, from which a program message is output and to which a numerical value is input when necessary. Various definition buttons on the menu bar 41 are pressed, whereby sub-configuration menus for the respective procedures are displayed. First, the definition of a conveyance path is described.

A conveyance path is defined by reading three-dimensional shape information from a three-dimensional computer-aided design (CAD). At this time, the shape of the conveyance path indicated by the three-dimensional shape information is converted into a set of triangular patches for efficiency of contact calculations. In the example of FIG. 4, this procedure is achieved by importing external data in a file menu. On the graphic screen 42, the shape of the conveyance path thus loaded into the program is displayed.

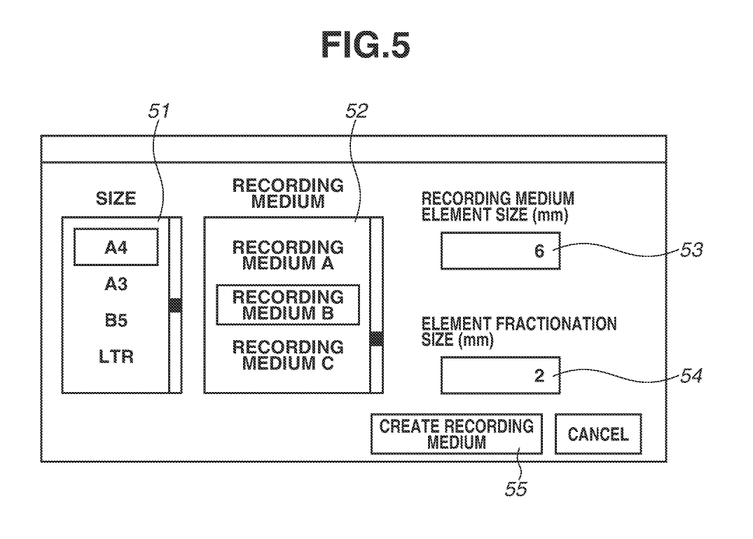

Next, a recording medium is selected. FIG. 5 is an example of a recording medium definition menu, which is displayed by pressing a recording medium definition button. The recording medium definition menu includes a size selection field 51, a recording medium type selection field 52, a recording medium element size field 53, an element fractionation size field 54, and a “create recording medium” button 55. In the example illustrated in FIG. 5, A4 is selected as the size of the recording medium. Next, a type of the recording medium is selected from the recording medium type selection field 52. In the example of FIG. 5, a recording medium B is selected. Next, a recording medium element size is input. In the example of FIG. 5, “6 mm” is input. Next, an element fractionation size is input. In the example of FIG. 5, “2 mm” is input.

Then, if the “create recording medium” button 55 is clicked with the mouse by a user, the CPU 21 stores the Young's modulus, which is a physical property value, the thickness, and the density of the recording medium in the RAM 25 using the selected type of the recording medium as a key in a built-in database. Next, based on the selected size of the recording medium and the input recording medium element size, the CPU 21 divides the recording medium into a plurality of elements discretized by a finite element method, thereby creating a finite element analysis model.

Next, based on the input element fractionation size, the CPU 21 divides an element surface, which is a surface of the finite element analysis model, into small areas. Then, the CPU 21 assigns a unique index to each of the small areas and calculates information indicating a portion of an element to which the small area corresponds, such as a range of shape functions in the finite element method. Then, the CPU 21 stores the calculated information in the RAM 25. In FIG. 5, since the recording medium element size is 6 mm, and the element fractionation size is 2 mm, a single element surface is divided into nine small areas.

Next, the setting of conveyance conditions is described. In the process of setting the conveyance conditions, the CPU 21 defines driving conditions for a conveyance roller, and the coefficients of friction between a conveyance guide and the conveyance roller, and the recording medium when the conveyance guide and the conveyance roller are in contact with the recording medium. Then, the CPU 21 stores the driving conditions and the coefficients of friction in the RAM 25. The conveyance conditions can be set by the user giving an instruction through “conveyance conditions” on the menu bar 41.

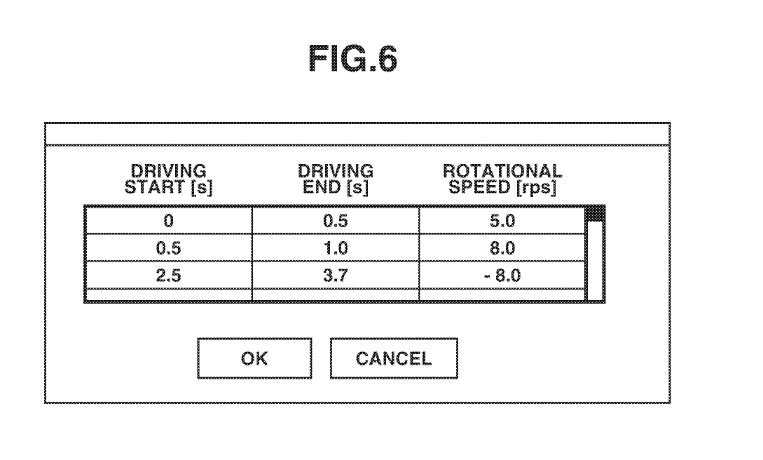

Regarding the driving conditions, a driving condition definition button is pressed, and each roller is selected, whereby a condition setting menu opens. In an example of FIG. 6, a table for a driving start time, a driving end time, and a rotational speed is created, whereby it is possible to create roller conveyance conditions such as an increase or decrease in speed and reverse rotation.

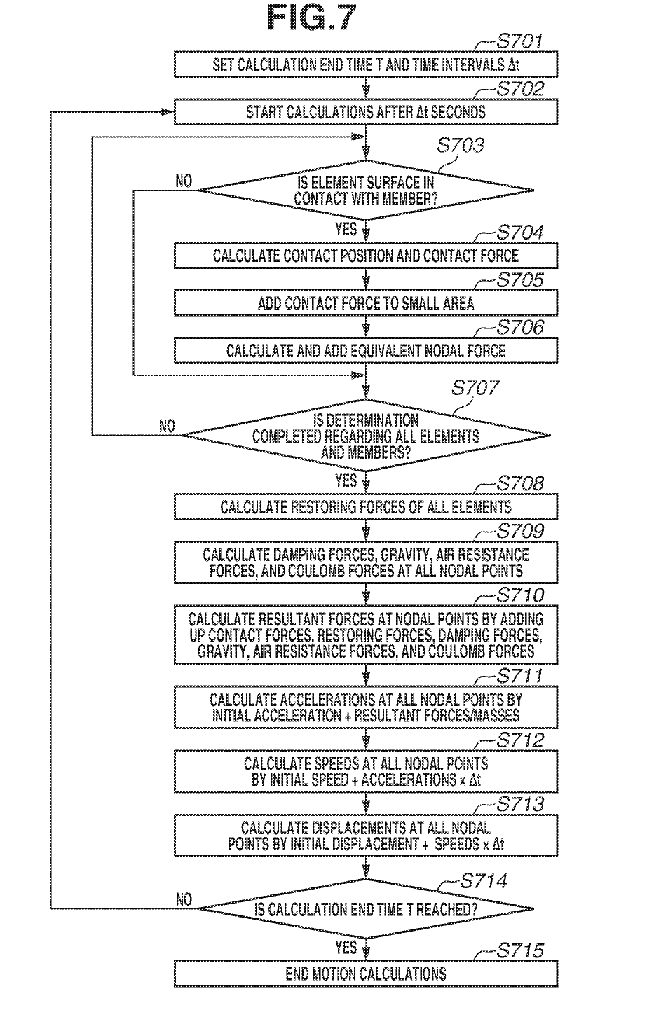

Next, with reference to a flowchart in FIG. 7, processing regarding the simulation execution unit 32 is described. In step S701, the CPU 21 first sets a real time (calculation end time) T until which the motion of a finite element analysis model is calculated, and time intervals Δt for numerical time integration to be used to numerically obtain solutions to equations of motion. As to T and Δt, values determined in advance may be used, or values indicated by the user may be used. Then, the CPU 21 calculates the motion of the finite element analysis model at each time, i.e., at each time step at each time interval Δt from an initial time to the calculation end time T, and stores the calculation result in the RAM 25. In the present exemplary embodiment, the calculation result is stored in the RAM 25, but may be saved in the storage unit 23.

Next, the motion calculations of the finite element analysis model at each time step are described. In step S702, the CPU 21 sets an initial acceleration, an initial speed, and an initial displacement that are necessary when calculations after Δt seconds are performed. Every time one time step ends, the calculation results at the time step (i.e., using values calculated at the previous time step as initial values) are input as these values. As the first values, values determined in advance are used.

Next, in step S703, the CPU 21 determines whether an element surface, which is a surface of the finite element analysis model, is in contact with a member as a contact target. If it is determined that the element surface is in contact with the member (YES in step S703), the processing proceeds to step S704. If not (NO in step S703), the processing proceeds to step S707.

In step S704, the CPU 21 calculates a contact position, a normal force, and a contact force such as a frictional force.

Next, in step S705, from information of the contact position calculated in step S704, the CPU 21 calculates the indices of small areas, thereby specifying the small areas. Then, the CPU 21 adds a contact force to each of the specified small areas and stores the calculation result in the RAM 25.

Next, in step S706, from information of the contact force and the contact position calculated in step S704, the CPU 21 calculates the equivalent nodal force of all the components of a contact force generated at each nodal point in the element, adds the calculated equivalent nodal force to the contact force at the nodal point in the element, and stores the calculation result in the RAM 25.

In step S707, the CPU 21 determines whether the determination in step S703 is completed for all the combinations of element surfaces, which are surfaces of the finite element analysis model, and members as contact targets. If the determination is not completed (NO in step S707), the determination in step S703 is executed for a next combination. If the determination is completed (YES in step S707), the processing proceeds to step S708.

In step S708, the CPU 21 calculates restoring forces of the respective elements of the finite element analysis model, adds the calculated restoring forces respectively to the restoring forces at the nodal points in the elements, and stores the calculation results in the RAM 25.

Next, in step S709, the CPU 21 calculates damping forces, gravity, air resistance forces, and Coulomb forces, which are forces acting on the finite element nodal points of the finite element analysis model in addition to the above forces, and stores the calculation results in the RAM 25.

Next, in step S710, as resultant forces acting on the respective finite element nodal points of the finite element analysis model at this time step, the CPU 21 adds up the forces acting on the respective finite element nodal points calculated in steps S706, S708, and S709 and stores the resultant force in the RAM 25.

Next, in step S711, the CPU 21 divides the resultant forces acting on the finite element nodal points obtained in step S710 by the respective masses of the finite element nodal points and adds the initial acceleration to the results of the division, thereby obtaining the accelerations of the finite element nodal points after Δt seconds.

Next, in step S712, the CPU 21 multiplies the accelerations obtained in step S711 by Δt and adds the initial speed to the results of the multiplication, thereby obtaining the speeds of the finite element nodal points after Δt seconds.

Next, in step S713, the CPU 21 multiplies the speeds obtained in step S712 by Δt and adds the initial displacement to the results of the multiplication, thereby obtaining the displacements of the finite element nodal points after Δt seconds.

In the present exemplary embodiment, as the calculations of the physical quantities after Δt seconds in the series of steps S711 to S713, the Euler time integration method is employed. Alternatively, another time integration method such as the Kutta-Merson method, the Newmark-β method, or the Wilson-θ method may be employed.

In step S714, the CPU 21 determines whether the calculation time reaches the set real time T. If the calculation time reaches the set real time T (YES in step S714), the motion calculation procedure ends. If the calculation time does not reach the set real time T (NO in step S714), the processing returns to step S702. In step S702, time integration is repeated, and if the calculation time reaches the set real time T, the motion calculations end.

In the present exemplary embodiment, only step S705 is added in the motion calculations, and therefore, an increase in the calculation time period is very small. On the other hand, to evaluate a local contact force by fractionating elements, the calculation time period increases due to increases in the numbers of elements and nodal points. Further, in a case where an explicit method such as the Euler time integration method employed in the present exemplary embodiment is used, there are limitations on the time intervals Δt for stable calculations, and Δt needs to be reduced approximately in proportion to the element size. As a result, the calculation time period increases due to an increase in the number of repetitions of time steps. In a case where the element size is reduced to one-third using shell elements as the finite elements of the recording medium, the calculation time period increases by approximately 27 times.

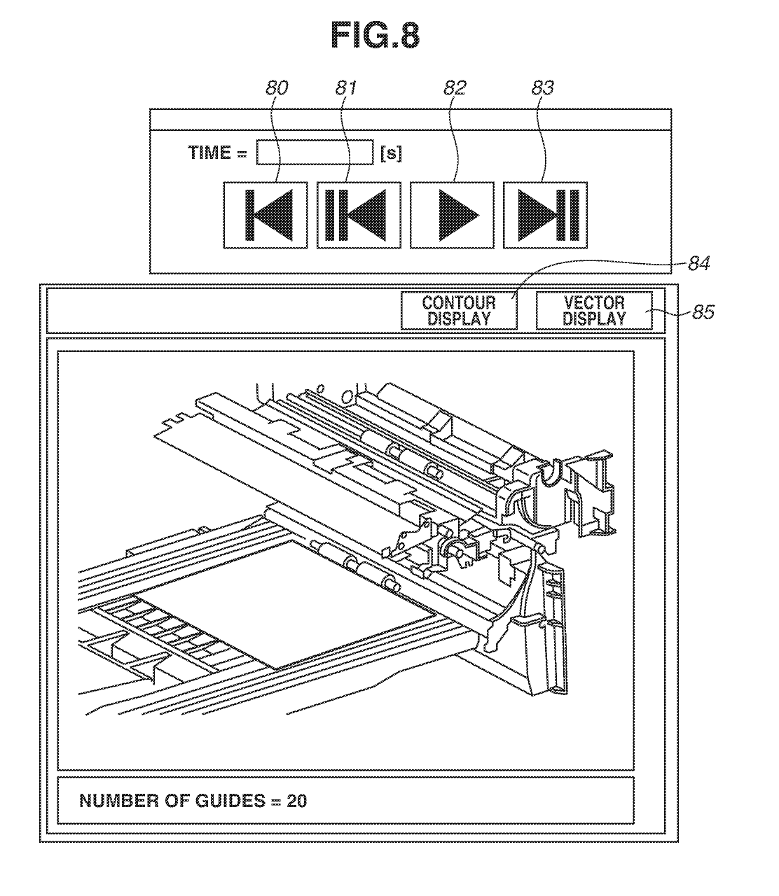

If the calculations end, the results are displayed. The execution results of the motion calculations can be confirmed by pressing a “result display” button. FIG. 8 is an example of an animation display menu. With a “playback” button 82, “frame-by-frame playback” buttons 81 and 83, a “return to initial step” button 80, a “contour display” button 84, and a “vector display” button 85, the calculated behavior of the recording medium is displayed using a geometric shape on a display screen, and the results of the calculations are displayed.

Next, the area-based contact force display unit 34 is described. The area-based contact force display unit 34 displays the contact force with respect to each of the small areas stored in step S705, using a contour or a vector in such a manner that a drawing area is a small area to which the transformation result of the finite element analysis model corresponds.

First, a contour display process is specifically described. If the contact force contour display setting button 84 on the animation operation screen illustrated in FIG. 8 is pressed, a contact force contour display setting menu for allowing contact force contour display settings is displayed. Then, according to the settings made in the contact force contour display setting menu, a contact force contour with respect to each small area is displayed.

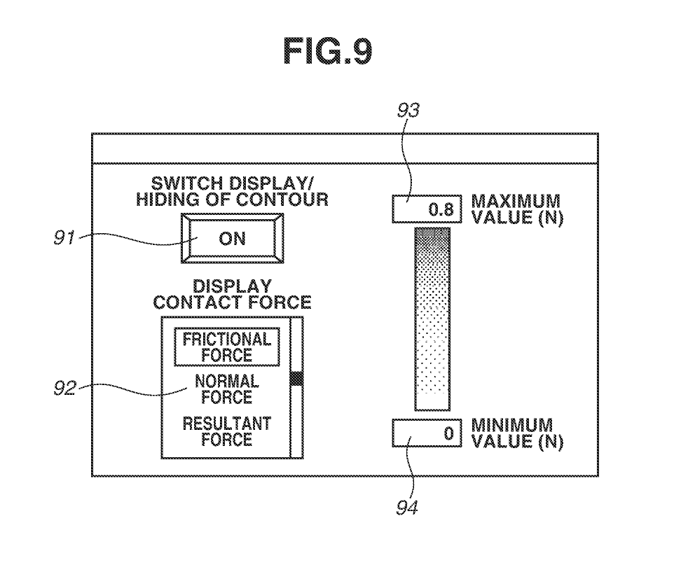

FIG. 9 is an example of the contact force contour display setting menu. The contact force contour display setting menu includes a contour display switching button 91, contour display contact force selection buttons 92, a contour maximum value entry field 93, and a contour minimum value entry field 94. To perform contour display, the contour display switching button 91 is selected to enable contour display. In FIG. 9, contour display is enabled. Next, one of the contour display contact force selection buttons 92 that corresponds to a contact force to be displayed is selected. In FIG. 9, a frictional force is selected. Next, values are input to the contour minimum value entry field 94 and the contour maximum value entry field 93. In FIG. 9, “0 N” is input to the contour minimum value entry field 94, and “0.8 N” is input to the contour maximum value entry field 93.

Then, if an OK button is clicked, the CPU 21 calculates the magnitudes of selected contact forces (frictional force vectors in this case) in all the small areas at all times stored in the RAM 25. From the calculated values of the magnitudes of the contact forces and the input contour minimum value and contour maximum value, the CPU 21 calculates the colors of the respective small areas at the respective times, and stores the calculated colors in the RAM 25.

Next, the CPU 21 performs the process of drawing small areas in the element surfaces of the finite element analysis model in the colors of the respective small areas at a result display time in units of element surfaces on the display unit 22. Also in a case where animation is reproduced, similarly, the CPU 21 performs the process of drawing small areas in the element surfaces of the finite element analysis model in the colors of the respective small areas at each result display time on the display unit 22.

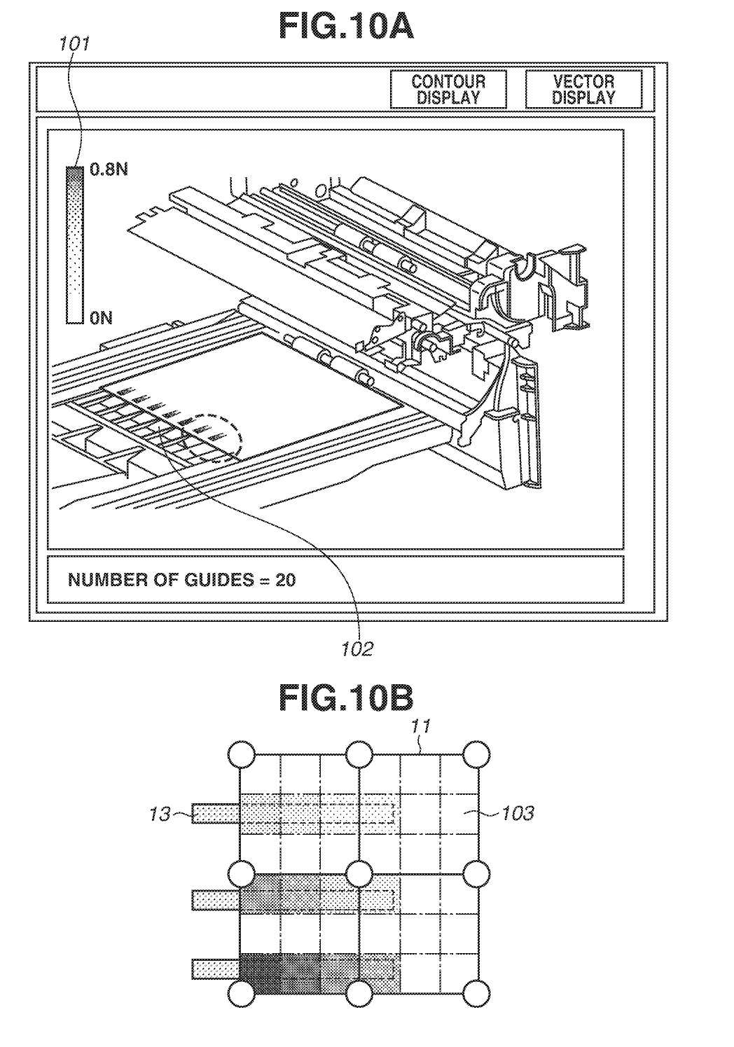

FIG. 10A is an example of an animation display menu when contact force contour display is executed. The greater the contact force of the small area in the element surfaces of the finite element analysis model, the darker the shade of the small area to be drawn. Further, in FIG. 10A, in addition to the example of the animation display menu in FIG. 8, a color bar 101 is displayed, which indicates the range of values of contours.

FIG. 10B is an enlarged view of a portion indicated by a dotted line 102 in FIG. 10A. In FIG. 10B, dashed-dotted lines 103 represent small areas having higher resolution than elements 11. It is possible to visually grasp a local contact force based on a conventional element size.

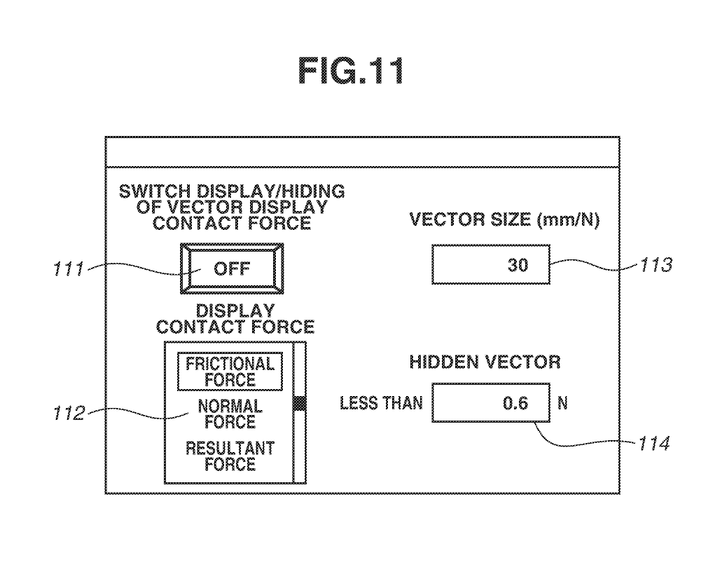

Next, a vector display process is specifically described. FIG. 11 is an example of a contact force vector display setting menu. The contact force vector display setting menu includes a vector display switching button 111, vector display contact force selection buttons 112, a vector display size entry field 113, and a hidden vector entry field 114. To perform vector display, the vector display switching button 111 is selected to enable vector display. In FIG. 11, vector display is enabled. Further, as a vector for use in vector display, either one of a vector representing the magnitude of a contact force and a vector representing a value obtained by converting a contact force into an equivalent nodal force of the finite element analysis model can be selectively displayed.

Next, one of the vector display contact force selection buttons 112 that corresponds to a contact force to be displayed is selected. In FIG. 11, a frictional force is selected.

Next, a value indicating what millimeters per N the magnitude of a vector is to be displayed in is input to the vector display size entry field 113. In FIG. 11, “30 mm/N” is input.

Next, if vectors are drawn for all contact forces including even minute contact forces, visibility deteriorates. Thus, a threshold for a vector to be hidden is input to the hidden vector entry field 114. In FIG. 11, “0.6 N” is input.

Then, if an OK button is clicked, the CPU 21 calculates selected contact forces (frictional force vectors of which the magnitudes are equal to or greater than the value input to the hidden vector entry field 114 in this case) in all the small areas at all times stored in the RAM 25. More specifically, the CPU 21 calculates from the input vector display size the vector length of a vector to be displayed, calculates a display vector by multiplying the vector length by a unitized contact force vector, and stores the display vector in the RAM 25.

Next, the CPU 21 performs the process of drawing display vectors at a result display time on the display unit 22 in such a manner that the starting points of the display vectors are the centers of the respective small areas in the element surfaces of the finite element analysis model at the result display time.

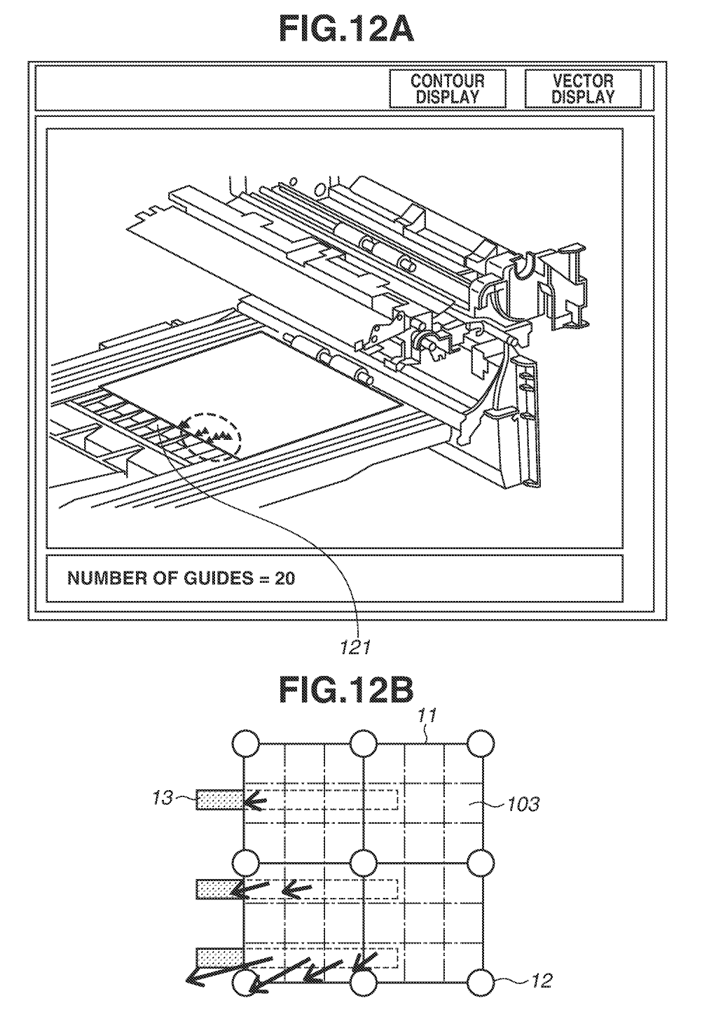

FIG. 12A is an example of an animation display menu when contact force vector display is executed. The greater the contact force of the small area in the element surfaces of the finite element analysis model, the longer the vector to be drawn. FIG. 12B is an enlarge view of a portion indicated by a dotted line 121 in FIG. 12A. It is possible to visually grasp a local contact force based on a conventional element size.

Based on the above display of a contact force according to the present exemplary embodiment, it is possible to visually grasp a local contact force, which is difficult to achieve without fractionating elements in the conventional art.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-089724, filed Apr. 28, 2017, which is hereby incorporated by reference herein in its entirety.

What is claimed is:

1. An information processing apparatus for simulating at each time a behavior of transformation caused by contact between a finite element analysis model discretized by a finite element method and a member as a contact target different from the finite element analysis model, the information processing apparatus comprising:
a division unit configured to divide an element surface, which is a surface of the finite element analysis model, into small areas smaller than the element surface;
a specification unit configured to specify each of the small areas where the finite element analysis model and the member come into contact with each other;
a storage unit configured to store a contact force with respect to each of the small areas; and
a display unit configured to read the contact force with respect to each of the small areas stored in the storage unit and display on a display screen the contact force with respect to each of the small areas with resolution higher than the element surface.

2. The information processing apparatus according to claim 1, wherein the finite element analysis model is a model obtained by discretizing a sheet-like recording medium by the finite element method.

3. The information processing apparatus according to claim 1, wherein the display unit provides a drawing area for drawing a transformation result after a simulation of the finite element analysis model and a geometric shape of the member, reads the contact force with respect to each of the small areas stored in the storage unit, and displays a magnitude of the contact force using a color in a small area included in the drawing area and corresponding to the element surface of the finite element analysis model.

4. The information processing apparatus according to claim 3, wherein the display unit performs, using a color or a shade in units of element surfaces, contour display of a value obtained by converting a contact force of the member into an equivalent nodal force of the finite element analysis model.

5. The information processing apparatus according to claim 1, wherein the display unit provides a drawing area for drawing a transformation result after a simulation of the finite element analysis model and a geometric shape of the member, reads the contact force with respect to each of the small areas stored in the storage unit, and displays a magnitude of the contact force using a vector in a small area included in the drawing area and corresponding to the element surface of the finite element analysis model.

6. The information processing apparatus according to claim 5, wherein the display unit selectively displays either one of the vector and a vector representing a value obtained by converting the contact force into an equivalent nodal force of the finite element analysis model.

7. The information processing apparatus according to claim 5, wherein the display unit displays, based on a setting of a display size of a vector, the vector.

8. The information processing apparatus according to claim 5, wherein the display unit displays, based on a threshold for a vector to be hidden, a vector representing a value equal to or greater than the threshold.

9. The information processing apparatus according to claim 1, wherein the storage unit adds up all components of the contact force generated in the same small area and stores the addition result.

10. The information processing apparatus according to claim 1, wherein the display unit displays, in a case where a contact force stored in the storage unit exceeds a threshold, a message notifying that the contact force exceeds the threshold.

11. An information processing method for controlling an information processing apparatus for simulating at each time a behavior of transformation caused by contact between a finite element analysis model discretized by a finite element method and a member as a contact target different from the finite element analysis model, the information processing method comprising:
dividing an element surface, which is a surface of the finite element analysis model, into small areas smaller than the element surface;
specifying each of the small areas where the finite element analysis model and the member come into contact with each other;
storing a contact force with respect to each of the small areas in a storage unit of the information processing apparatus; and
reading the contact force with respect to each of the small areas stored in the storage unit and displaying on a display screen of the information processing apparatus the contact force with respect to each of the small areas with resolution higher than the element surface.

12. The information processing method according to claim 11, wherein the finite element analysis model is a model obtained by discretizing a sheet-like recording medium by the finite element method.

13. The information processing method according to claim 11, wherein a drawing area for drawing a transformation result after a simulation of the finite element analysis model and a geometric shape of the member is provided, the contact force with respect to each of the small areas stored in the storage unit is read, and a magnitude of the contact force is displayed using a color in a small area included in the drawing area and corresponding to the element surface of the finite element analysis model.

14. The information processing method according to claim 13, wherein, using a color or a shade in units of element surfaces, contour display of a value obtained by converting a contact force of the member into an equivalent nodal force of the finite element analysis model is performed.

15. The information processing method according to claim 11, wherein a drawing area for drawing a transformation result after a simulation of the finite element analysis model and a geometric shape of the member is provided, the contact force with respect to each of the small areas stored in the storage unit is read, and a magnitude of the contact force is displayed using a vector in a small area included in the drawing area and corresponding to the element surface of the finite element analysis model.

16. The information processing method according to claim 15, wherein either one of the vector and a vector representing a value obtained by converting the contact force into an equivalent nodal force of the finite element analysis model is selectively displayed.

17. The information processing method according to claim 15, wherein the vector is displayed based on a setting of a display size of a vector.

18. The information processing method according to claim 11, wherein all components of the contact force generated in the same small area are added up, and the addition result is stored in the storage unit.

19. The information processing method according to claim 11, wherein in a case where a contact force stored in the storage unit exceeds a threshold, a message notifying that the contact force exceeds the threshold is displayed.

20. A non-transitory computer-readable storage medium storing a program for causing a computer to execute a control method for simulating at each time a behavior of transformation caused by contact between a finite element analysis model discretized by a finite element method and a member as a contact target different from the finite element analysis model, the method comprising:
dividing an element surface, which is a surface of the finite element analysis model, into small areas smaller than the element surface;
specifying each of the small areas where the finite element analysis model and the member come into contact with each other;
storing a contact force with respect to each of the small areas in a storage unit of an information processing apparatus; and
reading the contact force with respect to each of the small areas stored in the storage unit and displaying on a display screen of the information processing apparatus the contact force with respect to each of the small areas with resolution higher than the element surface.
